(19) United States
(12) Patent Application Publication
(10) Pub. No.: US 2015/0310376 A1
(43) Pub. Date: Oct. 29, 2015

(54) DIAGNOSTIC ASSISTANCE SYSTEM, DIAGNOSTIC ASSISTANCE METHOD, AND RECORDING MEDIUM

(71) Applicant: NEC CORPORATION, Tokyo (JP)

(72) Inventors: Kenichi KAMIJO, Tokyo (JP); Akira SAITO, Tokyo (JP)

(73) Assignee: NEC Corporation, Tokyo (JP)

(21) Appl. No.: 14/652,455

(22) PCT Filed: Dec. 16, 2013
(86) PCT No.: PCT/JP2013/007374

§ 371 Date: Jun. 16, 2015

(30) Foreign Application Priority Data
Dec. 18, 2012 (JP) 2012-275849

(51) Int. Cl. G06Q 10/06

(52) U.S. Cl. CPC G06Q 10/063112; G06Q 50/22

(57) ABSTRACT

Provided is a diagnostic assistance system whereby it is possible to allocate to highly skilled pathologists boundary region tissue specimens whereupon a malign/benign determination is difficult. The diagnostic assistance system includes: an input element for receiving an input of a degree of malignancy of a tissue specimen; a storage element for associating and storing a diagnostician with the degree of skill thereof; and a control element for, when the degree of malignancy is an intermediate value, querying the storage element and determining the diagnostician with the degree of degree of skill which is greater than or equal to a reference value.

### TECHNICAL FIELD

The present invention relates to a diagnostic assistance system, a diagnostic assistance method and a recording medium which assist a job of assigning a large number of pathological tissue specimens to a plurality of pathologists.

### BACKGROUND ART

In a medical test center or a large base hospital, a plurality of pathologists carries out pathological diagnoses to a large number of pathological tissue specimens. The pathological tissue specimen is made by a medical test engineer, and after a pathologist who is in charge of diagnosis is determined, the pathologist uses the pathological tissue specimen when observing the pathological tissue specimen by use of a microscope and the like and carrying out diagnosis whether suffering from a cancer (malignant) or not (benignant). In consideration of information on the pathologist such as working days, skill, a special organ, a process time of the pathologist or the like, the medical test engineer determines who out of the pathologists should carry out diagnosis to each of the pathological tissue specimens. At this time, it is necessary to assign the pathological tissue specimen to the suitable pathologist. However, the suitable assignment is not always carried out since the assignment is carried out on the basis of an empirical rule of the medical test engineer. Especially, even in the case that it is difficult to diagnose the tissue specimen, a subjective judgment is carried out on the basis of the empirical rule of the medical test engineer. As a result, accuracy and consistency in the judgment is not sufficient.

PTL 1 discloses an art related to a pathological diagnosis system for searching for a pathologist (requested pathologist) who is requested for an opinion on a disease case as the second opinion. As a method of searching for the requested pathologist, PTL 1 describes that, on the basis of search items (a type of organ, a target tissue area, a degree of cancer potential; a schedule, diagnostic experience (number of diagnoses)) for the pathologist, a sample which has high degree of cancer potential is assigned preferentially to a pathologist who has much diagnostic experience (number of diagnoses).

### CITATION LIST

### Patent Literature

PTL 1: Japanese Patent Application Laid-Open Publication No. 2011-181015

### SUMMARY OF INVENTION

### Technical Problem

However, the art described in the above-mentioned patent literature has the following problem. That is, the medical test engineer cannot assign the tissue specimen, which is in a boundary area where it is difficult to judge whether being malignant or not, to a pathologist who has the high level of skill. As a result, there is a fear that a misdiagnosis is caused.

An object of the present invention is to provide a diagnostic assistance system, a diagnostic assistance method and a recording medium which records a diagnostic assistance program.

### Solution to Problem

In order to achieve the object, a diagnostic assistance system according to one aspect of the present invention includes: an input unit configured to input a degree of malignancy of a tissue specimen; a storage unit configured to store a diagnostician and a skill level thereof which are associated each other; and in the case that the degree of malignancy is an intermediate degree, a control unit configured to determine the diagnostician, whose skill level is equal to or higher than a reference level, with reference to the storage unit.

A diagnostic assistance method according to one aspect of the present invention includes: inputting a degree of malignancy of a tissue specimen; storing a diagnostician and a skill level thereof which are associated each other; and determining the diagnostician, whose skill level is equal to or higher than a reference level, in the case that the degree of malignancy is an intermediate degree.

A computer-readable recording medium according to one aspect of the present invention records a diagnostic assistance program causing a computer to execute: an input step of inputting a degree of malignancy of a tissue specimen; a store step of storing a diagnostician and a skill level thereof which are associated each other; and a control step of determine the diagnostician, whose skill level is equal to or higher than a reference level, with reference to the skill level stored in the storage step, in the case that the degree of malignancy is an intermediate degree.

### Advantageous Effects of Invention

According to the present invention, it is possible to reduce a misdiagnosis risk at a time when diagnosing the tissue specimen.

### BRIEF DESCRIPTION OF DRAWINGS

FIG. 1 is a diagram illustrating a configuration of a diagnostic assistance system in a first exemplary embodiment.

FIG. 2 is a diagram illustrating a table which is stored in a storage unit and in which a diagnostician and a skill level thereof are associated each other.

FIG. 3 is a diagram illustrating an operational procedure of the diagnostic assistance system in the first exemplary embodiment.

FIG. 4 is a diagram illustrating a configuration of a diagnostic assistance system in a second exemplary embodiment.

### DESCRIPTION OF EMBODIMENTS

### First Exemplary Embodiment

Hereinafter, an exemplary embodiment of a diagnostic assistance system 100 according to the present invention will be explained with reference to a drawing. However, each component, which is described in the following exemplary embodiment, is merely exemplified, and technical scope of the present invention is not limited to each the component.

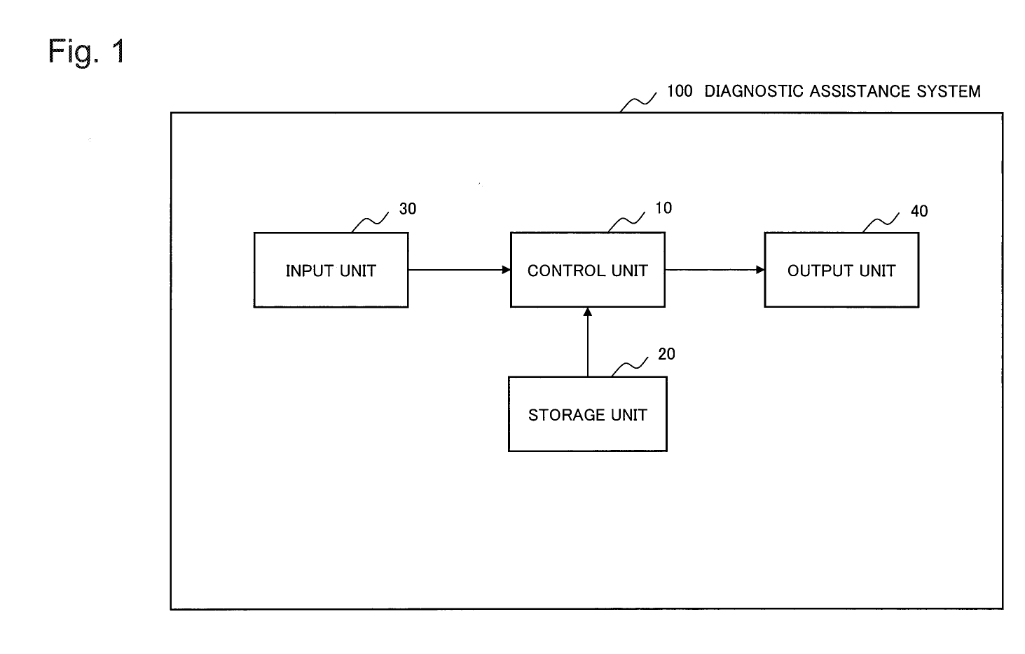

FIG. 1 is a diagram illustrating a configuration of the diagnostic assistance system 100 of the present exemplary embodiment. The diagnostic assistance system 100 of the present exemplary embodiment includes a control unit 10, a storage unit 20, an input unit 30 and an output unit 40. Here, each unit of each exemplary embodiment, which is included in a data management apparatus or the like, is composed of hardware such as a logical circuit or the like. Moreover, the units are composed of a control circuit of a computer, a storage device, a program loaded in the storage device, a storage unit such as a hard disk storing a program or the like, and may be implemented by an optional combination of hardware and software. Furthermore, a method for implementation, and an apparatus have no limitation as far as remark is not described.

In the case that a degree of malignancy of a tissue specimen which is an object of diagnosis is an intermediate degree, the control unit 10 determines a diagnostician, whose skill level is equal to or higher than a reference level, as a diagnostician who diagnoses the tissue specimen with reference to the storage unit 20. Here, the intermediate degree means a value which indicates a boundary area where, when judging the degree of malignancy of the tissue specimen, it is difficult to judge whether the tissue specimen is a malignant one or a benignant one. For example, in the case that a degree of malignancy judging system of the tissue specimen, which outputs the degree of malignancy in a range of 0 to 1.0, an output value of a range of 0.25 to 0.75 is defined as the intermediate degree of the degree of malignancy.

The storage unit 20 stores the diagnostician who diagnoses the tissue specimen, and the skill level thereof which are associated each other. The skill level becomes high as number of the tissue specimens which the diagnostician diagnoses or number of years when the diagnostician experiences diagnostic job become large. The input unit 30 acquires the degree of malignancy of the tissue specimen, which is a target for diagnosis, from a user's terminal or the like which is connected with the diagnostic assistance system 100. The output unit 40 outputs the diagnostician of tissue specimen, who is determined by the control unit 10, to the user's terminal or the like.

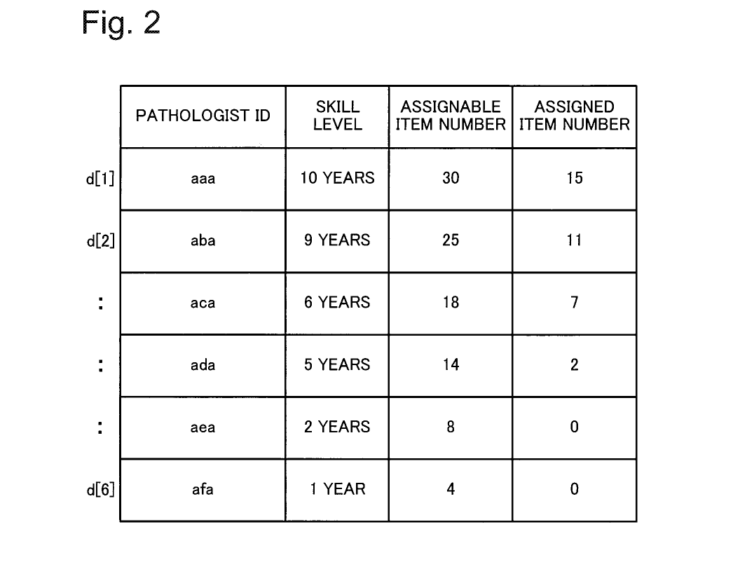

FIG. 2 is a diagram illustrating a table which is stored in the storage unit 20 and in which the diagnostician and the skill level thereof are associated each other. Specifically, the table is a matrix whose row is a record d[i] including a pathologist ID, the skill level, assignable item number of the specimens and assigned item number of the specimens, where i is an integer of 1 to number of pathologists. Here, it is assumed in the present exemplary embodiment that the skill level of the pathologist is expressed, for example, by number of years when the pathologist experiences the diagnosis.

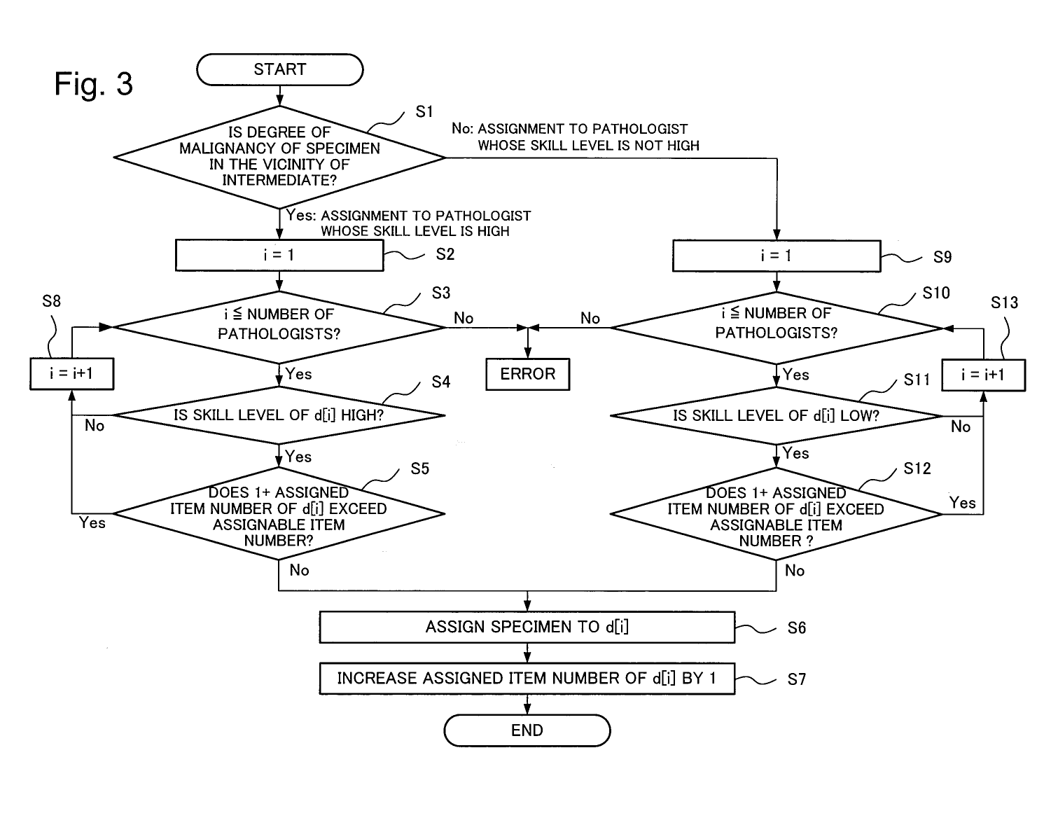

FIG. 3 is a diagram illustrating an operational procedure up to assigning the tissue specimen to the pathologist, who has the high skill level, in the diagnostic assistance system 100.

Firstly, when the degree of malignancy of the tissue specimen is input by the input unit 30, the control unit 10 determines whether the degree of malignancy is the intermediate degree or not (S1).

(In the case that the degree of malignancy is the intermediate degree)

In the case that the control unit 10 determines that the degree of malignancy is the intermediate degree, the control unit 10 reads the table shown in FIG. 2 from the storage unit 20, and searches for a pathologist to which the tissue specimen is assigned. The control unit 10 sets a suffix i to be 1 (S2). With reference to FIG. 2, since number of pathologists d[i] who are the target for assignment is 6, a condition of ‘suffix i≧number of pathologists’ is satisfied (Yes in S3). Furthermore, the control unit 10 determines whether the skill level of each pathologist is equal to or higher than a predetermined reference level (S4). The predetermined reference level means, for example, that number of years when experiencing the diagnosis is 5 years or more. With reference to FIG. 2, the control unit 10 determines firstly whether a skill level of a pathologist aaa corresponding to d[1] is equal to or higher than the predetermined reference level. Since the skill level of the pathologist aaa corresponding to d[1] is 10 years, the control unit 10 determines that the skill level of the pathologist aaa is higher than the predetermined reference level (Yes in S4). At this time, in the case that the skill level of the pathologist aaa corresponding to d[1] is as low as or lower than the predetermined reference level, the control unit 10 determines next whether a skill level of a pathologist aba corresponding to d[2] is equal to or higher than the predetermined reference level (No in S4, S8, S3 and S4).

Afterward, the control unit 10 repeats the process until a pathologist who has the high skill level is found (loop including S3, S4 and S8).

Next, the control unit 10 determines whether a number obtained by adding 1 to an assigned item number of the pathologist who has the high skill level, for example, the pathologist aaa corresponding to d[1] exceeds an assignable number or not (S5). According to the example shown in FIG. 2, since the number obtained by adding 1 to the assigned item number of the pathologist aaa corresponding to d[1] does not exceed the assignable number, the control unit 10 determines that it is possible to assign the tissue specimen to the pathologist aaa (No in S5), and assigns the tissue specimen to the pathologist aaa, and outputs an ID of the pathologist aaa (S6). Finally, the control unit 10 updates the assigned item number of the pathologist aaa by adding 1 to the assigned item number (S7).

In the case that the number obtained by adding 1 to the assigned item number of the pathologist aaa, who is corresponding to d[1], exceeds the assignable item number, the control unit 10 determines next whether a number obtained by adding 1 to an assigned item number of a pathologist who has the second high skill level, for example, the pathologist aba corresponding to d[2] exceeds an assignable item number or not (No in S4, S8, S3 and S4).

Afterward, the control unit 10 repeats the process until a pathologist to whom the tissue specimen should be assigned is found.

(In the case that the degree of malignancy is not the intermediate degree)

In the case that the degree of malignancy of the tissue specimen is not the intermediate degree, for example, in the case that the degree of malignancy is extremely high or extremely low, the control unit 10 searches for a pathologist, whose assigned item number does not reach an assignable item number, in an order of the low skill level, and assigns the tissue specimen to the pathologist (S9 to S13). Here, the case that the degree of malignancy is extremely high means, for example, a case that the degree of malignancy is 1.0, and the case that the degree of malignancy is extremely low means, for example, a case that the degree of malignancy is 0. Since a specific flow up to the search is the same as one of the above-mentioned example, explanation on the flow is omitted.

According to the diagnostic assistance device 100, it is possible to reduce a misdiagnosis risk which is caused when diagnosing the tissue specimen. The reason is that, in the case that the control unit 10 determines that the degree of malignancy of the tissue specimen is the intermediate degree, the control unit 10 assigns the diagnosis of the tissue specimen to the pathologist, who has the high skill level, with reference to the storage unit 20.

### Second Exemplary Embodiment

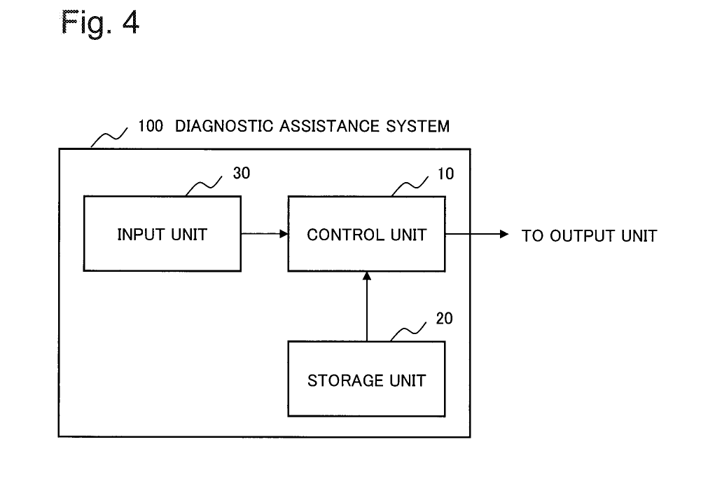

FIG. 4 is a diagram illustrating a configuration of a diagnostic assistance system 100 of a second exemplary embodiment of the present invention. The diagnostic assistance system 100 according to the present exemplary embodiment includes a control unit 10, a storage unit 20 and an input unit 30. In the case that the control unit 10 determines that a degree of malignancy of a tissue specimen is an intermediate degree, the control unit 10 determines a diagnostician whose skill level is equal to or higher than a reference level. The storage unit 20 stores the diagnostician and the skill level thereof which are associated each other. The input unit 30 inputs a degree of malignancy of the tissue specimen.

The diagnostic assistance system 100 according to the present exemplary embodiment can reduce a misdiagnosis risk when diagnosing the tissue specimen. The reason is that, in the case that the control unit 10 determines that the degree of malignancy of the tissue specimen is the intermediate degree, the control unit 10 assigns the diagnosis of the tissue specimen to the pathologist, who has the high skill level, with reference to the storage unit 20.

While the present invention has been explained with reference to the exemplary embodiments, the present invention is not limited to the above-mentioned exemplary embodiments. It is possible to add various modifications, which are apparent to a person skilled in the art, to the composition and the details of the invention of the present application within the scope of the invention of the present application.

This application is based upon and claims the benefit of priority from Japanese Patent Application No. 2012-275849, filed on Dec. 18, 2012, the disclosure of which is incorporated herein in its entirety by reference.

### REFERENCE SIGNS LIST

10 control unit

20 storage unit

30 input unit

40 output unit

100 diagnostic assistance system

1. A diagnostic assistance system, comprising:
an input means which inputs a degree of malignancy of a tissue specimen;
a storage means which stores a diagnostician and a skill level thereof which are associated each other; and
a control means which, in the case that the degree of malignancy is an intermediate degree, determines the diagnostician, whose skill level is equal to or higher than a reference level, with reference to the storage means.

2. The diagnostic assistance system according to claim 1, wherein
the intermediate degree is between a predetermined minimum boundary value and a predetermined maximum boundary value.

3. The diagnostic assistance system according to claim 1, wherein
the storage means stores furthermore assignable item number of the tissue specimens to the diagnostician, and assigned item number of the tissue specimens to the diagnostician which are associated with the diagnostician, and the control means determines the diagnostician whose assigned item number is smaller than the assignable item number.

4. A diagnostic assistance method, comprising:
inputting a degree of malignancy of a tissue specimen;
storing a diagnostician and a skill level thereof which are associated each other; and
determining the diagnostician, whose skill level is equal to or higher than a reference level, in the case that the degree of malignancy is an intermediate degree.

5. The diagnostic assistance method according to claim 4, wherein
the intermediate degree is between a predetermined minimum boundary value and a predetermined maximum boundary value.

6. The diagnostic assistance method according to claim 4, further comprising:
storing assignable item number of the tissue specimens to the diagnostician, and assigned item number of the tissue specimens to the diagnostician which are associated with the diagnostician; and
determining the diagnostician whose assigned item number is smaller than the assignable item number.

7. A computer-readable recording medium which records a diagnostic assistance program causing a computer to execute:
an input step of inputting a degree of malignancy of a tissue specimen;
a storage step of storing a diagnostician and a skill level thereof which are associated each other; and
a control step of determining the diagnostician, whose skill level is equal to or higher than a reference level, with reference to the skill level stored in the storage step, in the case that the degree of malignancy is an intermediate degree.

8. The recording medium according to claim 7, wherein
the intermediate degree is between a predetermined minimum boundary value and a predetermined maximum boundary value.

9. The recording medium according to claim 7, wherein
in the storage step, assignable item number of the tissue specimens to the diagnostician, and assigned item number of the tissue specimens to the diagnostician, which are associated with the diagnostician, are stored furthermore; and wherein
in the control step, the diagnostician, whose assigned item number is smaller than the assignable item number, is determined.

10. The diagnostic assistance system according to claim 2, wherein
the storage means stores furthermore assignable item number of the tissue specimens to the diagnostician, and assigned item number of the tissue specimens to the diagnostician which are associated with the diagnostician, and the control means determines the diagnostician whose assigned item number is smaller than the assignable item number.

11. The diagnostic assistance method according to claim 5, further comprising:
storing assignable item number of the tissue specimens to the diagnostician, and assigned item number of the tissue specimens to the diagnostician which are associated with the diagnostician; and
determining the diagnostician whose assigned item number is smaller than the assignable item number.

12. The recording medium according to claim 8, wherein
in the storage step, assignable item number of the tissue specimens to the diagnostician, and assigned item number of the tissue specimens to the diagnostician, which are associated with the diagnostician, are stored furthermore; and wherein
in the control step, the diagnostician, whose assigned item number is smaller than the assignable item number, is determined.
